(19) United States
(12) Patent Application Publication
(10) Pub. No.: US 2012/0204112 A1
(43) Pub. Date: Aug. 9, 2012

(54) METHOD FOR FACILITATING THE INTRODUCTION OF USERS WITH SIMILAR OR COMPLEMENTARY INTERESTS IN A GIVEN LOCALE WITHIN A GIVEN TIMEFRAME

(76) Inventors: Joshua D. Levine, Chapel Hill, NC (US); Robert A. Levine, Guilford, CT (US)

(21) Appl. No.: 13/367,254

(22) Filed: Feb. 6, 2012

Related U.S. Application Data
(60) Provisional application No. 61/439,663, filed on Feb. 4, 2011.

(51) Int. Cl. G06F 3/048

(52) U.S. Cl. 715/733

(57) ABSTRACT

A method of confirming a meeting time, date or location for a pre-selected activity wherein two or more users on a social utility website or app interact is provided. The method includes the following steps: a) both users indicate times and dates they are available to meet; b) both users indicate the geographical parameters within which they are available to meet; c) the website provides both users with a set of results that includes a list of options within the intersecting choices of both users; d) one user selects an option on the list, which is then highlighted on the second user's screen; e) the second user may click on the highlighted option to confirm, or alternatively click on a different selection, which is then highlighted on the first user's screen; and f) when an item is chosen by both users, it is displayed as confirmed on both users' screens.

The present application is entitled to the benefit of and incorporates by reference essential subject matter disclosed in U.S. Provisional Patent Application Ser. No. 61/439,663.

### BACKGROUND OF THE INVENTION

1. Technical Field

The present invention relates to a website and/or an “app” in general, and to a website and/or an “app” for facilitating the introduction of users with similar or complementary interests in a given locale within a given timeframe in particular.

2. Background Information

Websites and “apps” (i.e., application software that may be downloaded onto a user's mobile phone or other device) exist for a number of social utilities. For example, dating websites allow users to select characteristics (e.g., age, gender, education, marital status, etc.) of other users with whom they wish to be matched for a date. There remains a need for a social utility website and/or app that: 1) is designed to match users wishing to engage in one of several very specific activities, which activities may be selected from a nested menu; and/or 2) is designed to match users wishing to engage in a selected activity at the present moment or at a time in the not-too-distant future.

### SUMMARY OF THE INVENTION

According to one aspect of the present invention, a method of determining and confirming a mutually agreeable meeting time, date and/or location for a pre-selected activity wherein two or more users on a social utility website or app interact using real-time text-based communication is provided. The method is performed in the following manner: a) both users indicate times and dates they are available to meet by clicking-on or manipulating a computer-generated graphic, selecting from a menu, or entering information on a keyboard; b) both users indicate the geographical parameters within which they are available to meet by clicking-on or manipulating a computer-generated graphic, selecting from a menu or entering information on a keyboard; c) the website or app provides both users with a set of results that includes a list of various options within the intersecting choices of both users displayed simultaneously on both users' screens in words or graphic form; d) one user selects an option on the list by clicking on a listed item, which is then highlighted on the second user's screen; e) the second user may click on the highlighted text or graphic to confirm the first user's selection, or alternatively click on a different selection, which is then highlighted on the first user's screen; f) when an item is chosen by both users, it is displayed as the confirmed item on both users' screens.

According to another aspect of the present invention, a method of determining and confirming a mutually agreeable activity wherein two or more users on a social utility website or app interact using real-time text-based communication is provided. The method is performed in the following manner: a) the website or app provides both users with a set of results that includes a list of various options within the intersecting choices of both users displayed on simultaneously on both users' screens in words or graphic form; b) one user may select an option on the list by clicking on a listed item, which is then highlighted on the second user's screen; c) the second user may click on the highlighted text or graphic to confirm the first user's selection, or alternatively click on a different selection which is then highlighted on the first user's screen; and d) when an item is chosen by both users, it is displayed as the confirmed item on both users' screens.

According to another aspect of the present invention, an interactive feature on a website or app which determines and graphically displays an intersecting/overlapping geographical area of interest between two or more users is provided. The interactive feature operates by: a) mapping the location of the first user via GPS or allowing the user to enter his current location manually; b) allowing the first user to set parameters via manual input or manipulating a computer generated map or other graphic of the distance he is willing to travel either in distance or time units; c) mapping the location of the second or additional user via GPS or allowing the user to enter his current location manually; d) allowing the second or additional users to set parameters via manual input or manipulating a computer generated map or other graphic of the distance he is willing to travel either in distance or time units; e) the website or app calculating the overlapping or intersecting area of interest; and f) presenting the overlapping geographical area of interest to one or more participating users.

According to another aspect of the present invention, a method for confirming a meeting date, time or location for a pre-selected activity for at least a first user and a second user of a social utility website or app is provided. The method includes the following steps: a) the first user and the second user using the social utility website or app to choose times and dates they are available to meet by clicking on or manipulating a computer-generated graphic; b) the first user and the second user using the social utility website or app to choose the geographical parameters within which they are available to meet by clicking on or manipulating a computer-generated graphic; c) the first user and the second user viewing a set of results simultaneously displayed on both users' screens by the social utility website or app, the set of results including a list of options with overlapping choices of both users; d) the first user selecting an option on the list by clicking on the option, which option is then highlighted on the second user's screen; e) the second user selecting the highlighted option to confirm the first user's selection, or alternatively selecting a different option, which is then highlighted on the first user's screen; f) when an option is selected by both users, displaying the option as a confirmed option on both users' screens.

These and other objects, features and advantages of the present invention will become apparent in light of the detailed description of the invention provided below, and as illustrated in the accompanying drawings.

### BRIEF DESCRIPTION OF THE DRAWINGS

FIG. 1 illustrates the graphical user interface of the website of the present invention.

FIG. 2 illustrates the graphical user interface of the website of the present invention.

FIG. 3 illustrates the graphical user interface of the website of the present invention.

FIG. 4 illustrates the graphical user interface of the website of the present invention.

FIG. 5 illustrates the graphical user interface of the website of the present invention.

FIG. 6 illustrates the graphical user interface of the website of the present invention.

FIG. 7 illustrates the graphical user interface of the website of the present invention.

FIG. 8 illustrates the graphical user interface of the website of the present invention.

### DETAILED DESCRIPTION OF THE INVENTION

The present invention describes a method that may be utilized on a website and or an app that is designed to function both as a web portal and a social utility, (hereinafter referred to as “the website”). The primary function of the social utility part of website is to match two or more users who are interested in participating in a selected activity at a selected time at a selected location. The user is also able to select the desired characteristics of the matches (such as age, gender, education, marital status, etc.) that they are initially shown. This social utility differs from dating sites in that: 1) it is designed to match users who are interested in engaging in a very specific activity (selected from an extensive nested menu as described below); 2) it is designed to match users who would like to engage in the activity in the present moment or at a time in the not too distant future (though it also allows users to select meeting times in the future).

According to another aspect of the method, a first user at a location may be matched with other users currently at that location who are interested in meeting to engage in a selected activity at the present time.

According to another aspect of the method, a first user may be matched with other users who are interested in meeting at a selected location (i.e., a location other than the users' present location) to engage in a selected activity at a selected time in the not-too-distant future.

According to another aspect of the method, an interactive time bar or picker wheel is provided that may be manipulated by the user to indicate the times the user is available to meet other users to participate in an activity.

According to another aspect of the method, an interactive calendar is provided that may be manipulated by the user to indicate the days the user is available to meet other users to participate in an activity.

According to another aspect of the method, an interactive map is provided that may be manipulated by the user to indicate the geographic areas in which the user is available to meet other users to participate in an activity.

According to another aspect of the method, a dynamic polling tally of “hits” in list or table form is provided that indicates the matches based on criteria selected by the user, the dynamic list being useful to guide the user to select criteria that return an acceptable and manageable number of results.

According to another aspect of the method, a multi-level, nested category display allows the user to easily select a number of criteria without use of a keyboard.

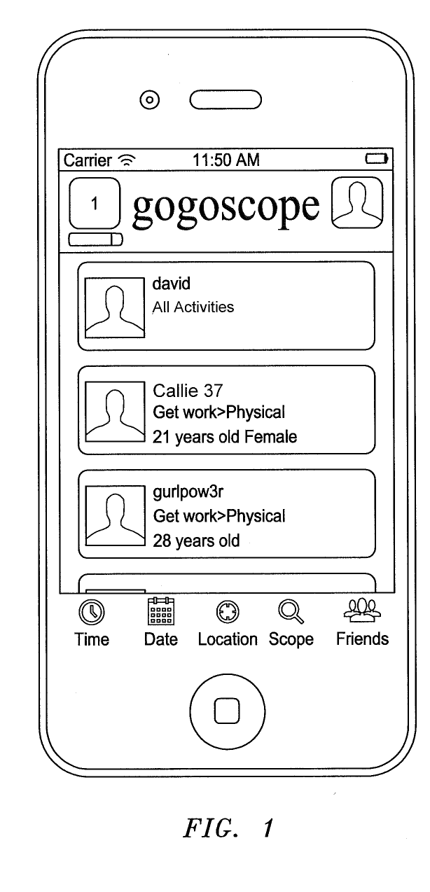

If a user is in a public venue (e.g., a restaurant, a coffee house, a nightclub, neighborhood pub, etc.) and would like to know which men or women are interested in meeting someone new for a drink, the user would type in his location (name of establishment, address (or allow GPS device to reveal their current location)), and select one or more of the “have a drink”, or “someone new”, or “within 20 minutes time” buttons from the proffered menus. A list of screen profiles of other users who had selected the same or overlapping criteria appears on his screen. By “overlapping criteria” it is meant that if user one selected a time frame of 12 PM to 6 PM and user two selected a time frame of 5 to 6 PM, an overlap would exist. The user may tap the screen profile (names and/or profile images) of the users he would like to meet. As shown, e.g., in FIG. 1, this action causes user 1's profile to become to become highlighted in a differentiating color and move to a prioritized position on user 2's search screen to indicate user 1's interest in matching with user 2. If-user 2 then taps user 1's screen profile, a confirmed match is made, and both user 1 and user 2's profiles are highlighted in new color and moved to the top on each of each other's screens. They may both be notified of the match via text and/or email and/or numerical counting badge and an IM box pops up next to the matching profile picture for them to arrange to meet. Also, a menu option may appear that allows one user the option to send the other user varying degrees of additional profile information (e.g., more photos, occupation, hometown, regular email address, etc.).

If the users are still at work or at home, and are interested in meeting someone for a social engagement (e.g., meet for a coffee, or a drink), they can specify the radius in miles they are willing to travel, or a particular town, and also the time they would like meet (e.g., within 1 hour to 2 hours.) In this case, when a match is made, a list of bars (ranked by a combination of reviews and/or advertising, business hours and other pertinent factors) pop-ups on the screen along with the dialogue box. One user could select his preference for meeting, which in turn, causes that establishment to be highlighted on the second user's screen. The second user may accept the meeting place by clicking the highlighted establishment, or suggest another place by clicking a different selection on the list. Clicks on the same listing by both users confirm the selection. Suggested meeting times then appear on both users' screens. As with place, times clicked by one user are highlighted on the second user's screen, who can then click the highlighted time to confirm, or click another time that they would prefer. A click by both users on a given time confirms. Next, a query asking if the user would like directions to the selected location appears. If he selects “yes”, a box appears within the screen providing a map and directions. He may also choose to allow or disallow a GPS tracking program that, based on his present location and mode of transport (e.g., driving, biking, walking, etc.), periodically notifies the second user of his estimated time of arrival at the selected location. An indicator alert may automatically be set to produce a sound to signal the user that he should leave his current location in order to arrive at a confirmed meeting location at the designated, confirmed time.

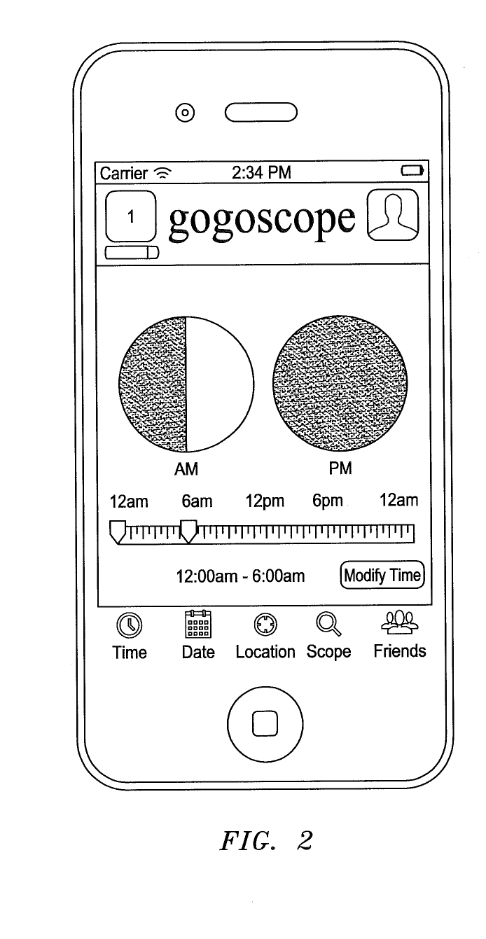

In the preferred embodiment there are three primary interactive graphics on the website, examples of which are shown in FIGS. 2-4. One would be a time bar, labeled with the hours of a day. An example of the time bar is shown in FIG. 2. On this bar may be two slidable time pointers, the first located at the present time, may be slid to indicate the earliest time the user could meet. The second marker may be slid to indicate the latest the user could stay at the designated meeting. Two circles representing two clock faces (one a.m. hours and one p.m. hours) are situated above the time line. As the two time pointers on the time line are manipulated, the circles fill with a designated color (as on a pie chart) indicating the hours the user is available to meet for a particular activity. The second user does the same, and his hours of availability appear on the first user's clocks in a different designated color, and vice-versa. Meeting times acceptable to both users (overlapping time arcs) appear on the clock faces as a mixture of the two colors. The website may then identify one or more meeting times and leaving times that were good for both users, and ask each user to confirm the time by both clicking on the same suggestion (as described above). It should be appreciated that this method will save time in planning meetings, requires little or no use of a keyboard (which is particularly helpful in mobile computing), and can be used to arrange meeting between any number of users.

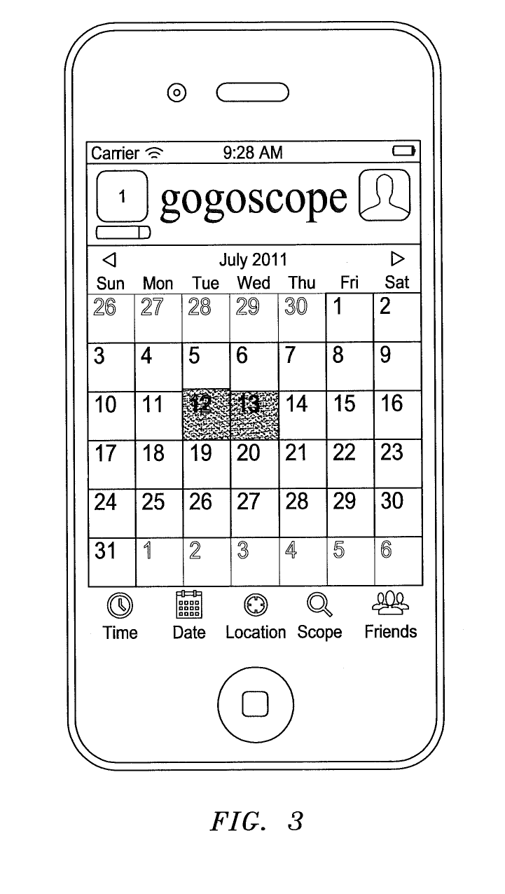

Referring now to FIG. 3, the second interactive graphic feature is a representation of a monthly calendar page with each square in the grid representing a day. The user may click on (or touch) the day he is available to meet. With each day selected, a time bar and clock face (or time picker wheel) appear which may be manipulated to show his hours of availability on that day. Clicking on one day, and the double clicking on a second day later in the month selects and highlights all the days in between the two selected dates as meeting possibilities. Touching on previously highlighted days un-highlights them, indicating non-availability that day. The interface works with a second or multiple users to select and confirm meeting times in the manner described above.

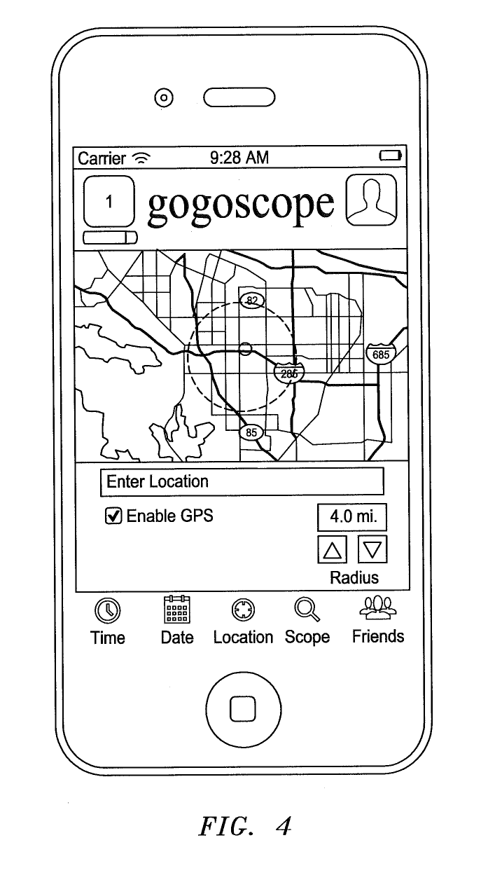

Referring now to FIG. 4, the third interactive feature, designating the locale of the meeting, most likely would be integrated with another mapping and direction website (e.g., Google maps). When a map appears on the user's page (as described above), his current location is marked with a point on the map. A bar with one sliding pointer indicating marked-off distance (in either miles or time units) is manipulated to select the radial distance the user would be willing to travel in order to meet. Alternatively, two interactive toggle boxes, one with an arrow pointing up, one with an arrow pointing down, may be tapped to increase or decrease the radial distance the user wishes to travel. The selection of distance (or travel time) is concurrently represented as a colored circle on the map above, e.g., as shown in FIG. 4. The distance selection may also be made on the interactive map itself by holding one finger at the starting location, and dragging a second finger to the chosen radial distance. The point expands to a circle when it is dragged, delineating the desired (radial) distance the user would like to travel. The second user's current location may or may not be shown (depending on privacy settings), but the overlapping selection of the two geographical areas selected (intersection of the two circles) may be shown in a second color on the map of the first user and vice-versa. A list of meeting places within the common intersecting geographical locations, and appropriate to the chosen activity, is provided.

An additional interactive feature displays a dynamic list or table of numerical tallies of matches based on the criteria selected by the user. For example, as the user decreased the geographical distance he was willing to travel from his current location to meet someone new for a drink, the numbers of “hits” listed in each of the categories/criteria he had selected (e.g., meeting time between 1 and 3 PM, interest in astronomy, college graduate, etc.) also decreases. This dynamic list would be useful to guide the user to select criteria that would return a manageable number of results, and/or guide the user to broaden his selected criteria (e.g., increase time range he is willing to meet, change interest category from astronomy to physical sciences) to find a greater number of matches. This feature would be particularly desirable on mobile computing devices where a smaller number of quality matches is often more useful than a very large number of matches. The user may choose to display the matches to his search only after the number of matches fell between pre-determined numerical parameters. An additional feature is that the user may select to turn on or off an audio or vibration alert or receipt of an email or text that notifies the user that a designated number of potential matches have been achieved.

It should be appreciated that this method of matching activities and people and times and locations can be used for any chosen activity in the realm of human activity (e.g., discussions of a particular book, bike rides in the country, playing cards, meeting others to play music together, etc.). The website and app are designed with broad categories of activities and within them, nesting menus that allow users to easily navigate to their particular interest. Users may define their particular social interest as broadly or narrowly as they like. The user may choose whether she would like to meet with a friend/previously confirmed match (friends may be imported from other social networking sites) or with someone new, or choose “either”. The user can also select a desired number of participants for a given activity (e.g., five people for moving a heavy piece of furniture, three people or more for a dog playgroup at a given park at a given time, etc.). When multiple matched are desired for a given activity, dialogue boxes along with time, locations and mapping features will pop-up next to all matches made.

It should also be appreciated that this social utility will allow those in transit (e.g., on planes, trains, boats, buses, etc.) to meet others with similar interests. This may work via a GPS device or by entering other information manually (e.g., flight number, train name and number, etc.).

The social utility may also be used to match an employer needing temporary help with employees looking for day work. The employer selects from the menu “need help” and then “for pay” (as opposed to volunteer—the other menu choice at the second nested level), and then select the type of help needed, and enter desired starting and ending times, and wage offered. The prospective employee selects “get job”, then perhaps “manual labor” or “IT assistance” (under types of work listed), and then select times available and acceptable pay range. Matches, dialogue boxes, meeting times and maps function as described above.

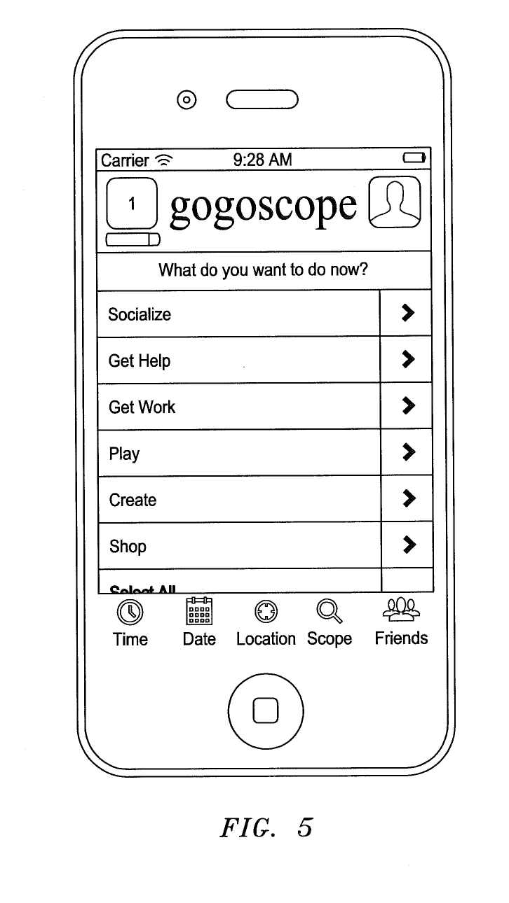

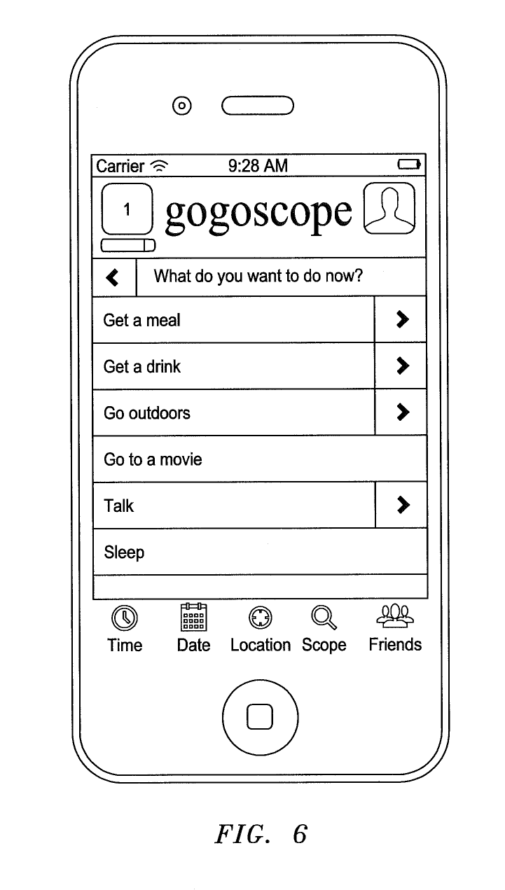

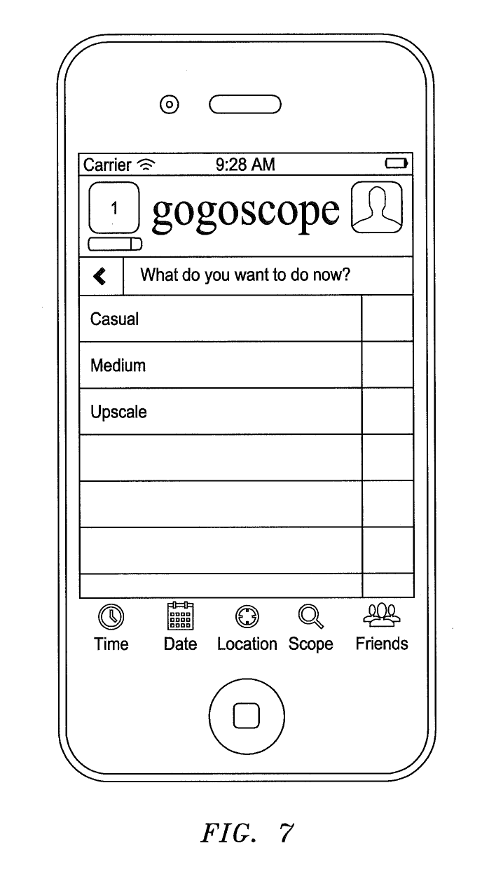

FIGS. 5-8 illustrate the nested activity levels on the website. Upon entering the website, the page shows the level one search categories. There is a box to enter the user's current locations and option to allow GPS. There is a box that contains the dynamic polling “hit” list, along with a toggle to turn real-time result counting on or off. As shown in FIG. 5, the header reads “What do you want to do now?” There are the following categories listed below: “Socialize”, “Get Help”, “Get Work”, “Play”, “Create”, “Shop”, etc. Upon clicking on one of these “level one” categories, the “level two” categories appear. As shown in FIG. 6, under the level one category “Socialize”, there are the following level two categories: “Get a meal”, “Get a drink”, “Go outdoors”, “Go to a movie”, etc. Upon clicking on one of these level two categories, “level three” categories appear. As shown in FIG. 7, under the level two category “Get a meal” there would be the following level three categories: “Casual”, “Medium”, “Upscale”. The present invention is not limited to the level one, level two and level three categories described with regard to FIGS. 5-7. Also, it is acknowledged that the list of level one categories described with regard to FIG. 5 (i.e., “Socialize”, “Get Help”, “Get Work”, “Play”, “Create”, “Shop”, etc.) operates as a nested menu; i.e., each level one category corresponds to one or more level two categories, and each of those level two categories corresponds to one or more level three categories, etc. For example, the level one category “Get Help” corresponds to the following level three categories: “Moving, “Cleaning”, “Errands”, “Repairs”, “Yard Work”, “Massage”, “Driving”. As another example, the level one category “Create” corresponds to the following level two categories: “Art”, “Music”, “Theatre”, “Film”, etc. The level two category “Art” is then broken down into a number of level three categories (e.g. “Paint”, “Draw”, “Sculpt”, “Photo”, etc.) The user may choose to search for all matches in a broad level one category, a narrower level two category, or if he is only interested in a very specific activity (e.g. “a walk in the park”), he may choose a level three selection.

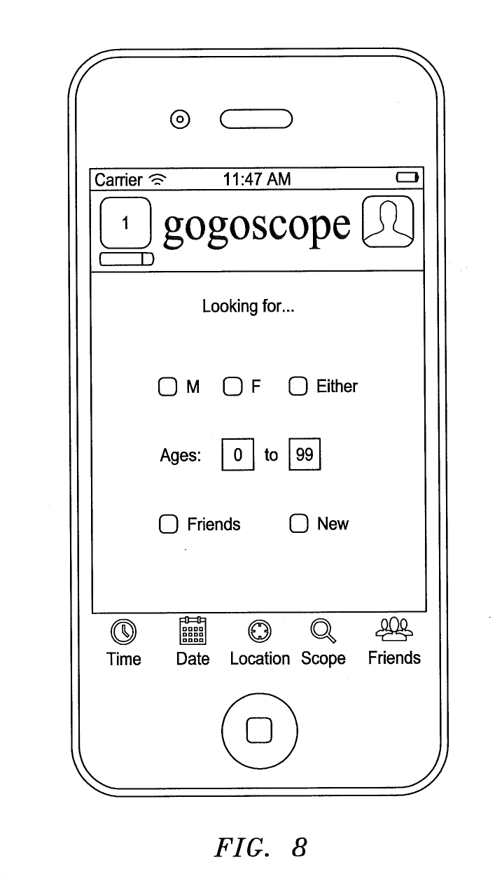

As shown in FIG. 8, the user may have the choice of getting matches from a previously complied “friends” database, from new people, or both. Also as shown in FIG. 8, the user could select desired gender and age criteria to search. In additional search menus the user may also be able to further select from a number of other search criteria (e.g., educational background, smoking preference, etc.).

The website may be monetized through ads from local businesses (retail and service), attractions and restaurants. Matches of people or stores or restaurants meeting the selected criteria may appear on the screen with the appropriate corresponding search. The list of businesses presented may be ranked by proximity, cost and reviews. The user could toggle the ranking system depending on their highest priority. The lists may include advertising establishments, which may be clearly identified (e.g. by font color or highlighted box, etc.) as paid promotional placements. Local businesses and attractions that were currently closed could be eliminated from matches or appear in the ranked list or presented in a faded font and/or graphics to designate their non-availability for the selected timeframe. In addition to the described advantages and uses for the user, the material entered by the user may be valuable to commercial interests since it characterizes the user demographically, geographically and by personal interest in engaging in an activity in a given timeframe. Both the users and commercial entity may benefit by the presentation and availability of targeted opportunities to the user and his matched partners. Small advertisements may be placed in side bars that correspond with the user's desired activity. A small fee may be charged for employers seeking employees. Income may also be generated through click-throughs to online stores and other websites. The clear, direct simplicity of the interface of the website will allow the users to easily find what they desire (whether social interaction, durable goods, or service) at any given moment.

Although this invention has been shown and described with respect to the detailed embodiments thereof, it will be understood by those skilled in the art that various changes in form and detail thereof may be made without departing from the spirit and the scope of the invention.

What is claimed is:

1. A method of determining and confirming a mutually agreeable meeting time, date, and/or location for a pre-selected activity wherein two or more users on a social utility website or app interact in the following manner
a) both users indicate times and dates they are available to meet by clicking-on or manipulating a computer-generated graphic, selecting from a menu, or entering information on a keyboard;
b) both users indicate the geographical parameters within which they are available to meet by clicking-on or manipulating a computer-generated graphic, selecting from a menu or entering information on a keyboard;
c) the website or app provides both users with a set of results that includes a list of various options within the intersecting choices of both users displayed simultaneously on both users' screens in words or graphic form;
d) one user selects an option on the list by clicking on a listed item, which is then highlighted on the second user's screen;
e) the second user may click on the highlighted text or graphic to confirm the first user's selection, or alternatively click on a different selection, which is then highlighted on the first user's screen; and
f) when an item is chosen by both users, it is displayed as the confirmed item on both users' screens.

2. The method of claim 1 where the number of users with matching or overlapping search criteria is listed on the user's computer, and that number is dynamically polled and changed when the selection criteria are altered by the user.

3. The method of claim 1 where both users are sent selected locales or businesses meeting the needs of their selected activity in their geographical area.

4. The method of claim 1 where a perceptible alarm, text or email notification is provided indicating that there are users with identical choices.

5. The method of claim 4, wherein the threshold number and/or the type of alarm and/or the sound or appearance of the alarm for delivery of the alarm is user controllable.

6. A method of determining and confirming a mutually agreeable activity wherein two or more users on a social utility website or app interact in the following manner
a) the website or app provides both users with a set of results that includes a list of various options within the intersecting choices of both users displayed simultaneously on both users' screens in words or graphic form;
b) one user may select an option on the list by clicking on a listed item, which is then highlighted on the second user's screen;
c) the second user may click on the highlighted text or graphic to confirm the first user's selection, or alternatively click on a different selection which is then highlighted on the first user's screen; and
d) when an item is chosen by both users, it is displayed as the confirmed item on both users' screens.

7. A feature on a computer or mobile computer device that calculates the time of day that an individual must leave a specific location in order to arrive at a second location at a specific time given the variables of means of transport.

8. The feature of claim 7 given the variables of current or expected travel conditions or delays.

9. The feature of claim 8 given a variable of rate of travel or means of transport inputted by the user.

10. An alert on a user's computer or mobile computer device operable to indicate to the user that he must leave his current location in order to arrive at a predetermined location for a meeting or event at a scheduled time.

11. The alert of claim 10, wherein the travel is one or more of on foot, by bicycle, by motor vehicle, or public transportation.

12. The alert of claim 10, wherein the meeting between users has been scheduled and confirmed in the manner described in claim 1.

13. An interactive feature on a website or app which determines and graphically displays an intersecting/overlapping geographical area of interest between two or more users by:
a) mapping the location of the first user via GPS or allowing the user to enter his current location manually;
b) allowing the first user to set parameters via manual input or manipulating a computer generated map or other graphic of the distance he is willing to travel either in distance or time units;
c) mapping the location of the second or additional user via GPS or allowing the user to enter his current location manually;
d) allowing the second or additional users to set parameters via manual input or manipulating a computer generated map or other graphic of the distance he is willing to travel either in distance or time units;
e) the website or app calculating the overlapping or intersecting area of interest; and
f) presenting the overlapping geographical area of interest to one or more participating users.

14. The feature of claim 13 wherein the information displayed after input from two or more users consists of a list of establishments, attractions or other places within the overlapping geographical areas calculated.

15. The feature of claim 13 wherein the information displayed highlights, or is limited to, locations relevant and open to an activity previously chosen by both or all users.

16. The feature of claim 13 wherein the overlapping area of interest is displayed graphically to one or more of the participating users as a shaded or colored portion of a computer-generated map.

17. The feature of claim 14 wherein the information displayed is limited to, or highlighted by listing order or by graphic means, locations previously chosen by both or all users which are open for said activity at the selected date and time.

18. A method for confirming a meeting date, time or location for a pre-selected activity for at least a first user and a second user of a social utility website or app, the method including the following steps:
a) the first user and the second user using the social utility website or app to choose times and dates they are available to meet by clicking on or manipulating a computer-generated graphic;
b) the first user and the second user using the social utility website or app to choose the geographical parameters within which they are available to meet by clicking on or manipulating a computer-generated graphic;
c) the first user and the second user viewing a set of results simultaneously displayed on both users' screens by the social utility website or app, the set of results including a list of options with overlapping choices of both users;
d) the first user selecting an option on the list by clicking on the option, which option is then highlighted on the second user's screen;
e) the second user selecting the highlighted option to confirm the first user's selection, or alternatively selecting a different option, which is then highlighted on the first user's screen;
f) when an option is selected by both users, displaying the option as a confirmed option on both users' screens.
